(19) United States
(12) Patent Application Publication
(10) Pub. No.: US 2017/0371481 A1
(43) Pub. Date: Dec. 28, 2017

(54) ENHANCED TOUCHSCREEN

(71) Applicant: Twin Harbor Labs LLC, Plano, TX (US)

(72) Inventor: James Logan, Candia, NH (US)

(21) Appl. No.: 15/634,963

(22) Filed: Jun. 27, 2017

Related U.S. Application Data
(60) Provisional application No. 62/355,412, filed on Jun. 28, 2016.

(51) Int. Cl. G06F 3/041; G06F 3/044; G06K 9/00; G06F 3/0488

(52) U.S. Cl. CPC G06F 3/0416; G06K 9/0002; G06F 3/044; G06F 3/04883; G06K 9/00375

(57) ABSTRACT

A mobile device with an enhanced touchscreen is described, the touchscreen incorporating input from an enhanced fingerprint reader that is capable of determining which finger is touching the screen and assigning different functionality to each finger. The specific finger that is used and the location of hovering fingers are mapped into commands for the operating system and other software on the mobile device.

### BACKGROUND OF INVENTION

### Field of the Invention

The present invention is directed to mobile computing devices input mechanisms and more specifically to touchscreens with enhanced capabilities.

### Description of the Related Art

Computer input devices have come a long way since switches were used to enter the programs in the 1940s. Punched cards, keyboards, paper tape led to computer mice, trackballs, and touchscreens. Today input devices focus on keyboards, mice, and touchscreens for computer systems and touchscreens for mobile devices.

Since Xerox invented the computer mouse on the Xerox Alto, the combination of a mouse with a keyboard has become a de facto standard for computing systems. Both Apple and Microsoft designed their operating systems and tools around the use of mice to make menu selections, to select which window is active, and to implement functionality. With the mouse, the old means for editing a program with metacharacters and key based commands has transformed into point and click inputs.

However, mobile systems lack the space availability for mice or keyboards, and are forced to rely on touchscreens as a user interface. But today's touchscreens lack the rich input functionality found on computer keyboard and mouse user interfaces. For instance, the ability to hover over menus with a mouse is missing from the touchscreen repertoire. And the right click functionality is left off of touchscreens due to the lack of ways to distinguish the type of touch on the screen. Much of the cursor movement feedback from a mouse has not been implemented in touchscreens. This has limited the ability of mobile device users to enjoy the versatility of inputs offered on computers with keyboards and mice.

Recently, William Mouyos and John Apostolos invented a new way to read fingerprints using a touchscreen in real time. See US Patent Publication US2014/0310804A1, incorporated herein by reference. This invention opens new opportunities to overcome the shortcomings articulated above, particularly by adding the ability to distinguish between fingers touching a touchscreen.

### SUMMARY OF THE INVENTION

A method for enhancing the functionality of a mobile device touchscreen by using fingerprint recognition algorithms from a touchscreen to detect where a user's fingers are located over the touchscreen and to identify which finger is touching the screen.

### BRIEF DESCRIPTION OF FIGURES

FIG. 1 is a drawing of a hand over a mobile device.

FIG. 2 is a drawing of a mobile device with a touchscreen mounted on the front.

### DETAILED DESCRIPTION OF THE INVENTION

With new technologies in touchscreens, particularly in the area of reading fingerprints through normal use of the touchscreen, the capability to distinguish which finger is used by a user is available to developers. With the capability, we explore enhanced user interfaces that assign different functionality based on fingerprints of specific fingers. These capabilities are applicable to mobile phones with touchscreens as well as tablets and personal computers. This functionality applies to touch pads as well as touchscreens, and could also be utilized in the user interfaces of embedded processors and stand-alone devices such as security touch screens and LCD screens (with touch capabilities) for devices such as copiers, printers, radios, a/v equipment, cameras, etc. A touchscreen is a transparent touch sensitive material that covers a screen used to determine where a user is touching on the screen, often used on mobile devices where keyboards and mice are not practical. A touchpad is a pad of touch sensitive material that is not covering a screen, often located below of beside the keyboard on a laptop computer.

### Cell Phone

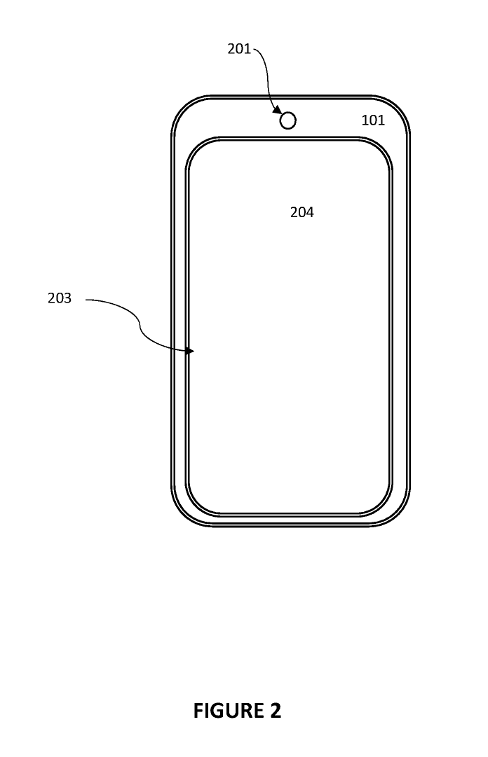

Looking to FIG. 2, we see a mobile device 101 such as a cell phone, a smart phone, a tablet, a smart watch or similar device is outfitted with a screen 203, a touchscreen 204 overlaying the screen, a processor with memory, one or more cameras 201, and communications interfaces such as cellular, Bluetooth, Wi-Fi, and other protocols. The mobile device 101 runs an operating systems such as Android, iOS, Windows, or similar. In addition, various applications run on the operating system, such as email programs, calendars, camera apps, file systems, editing software, games, map apps, calculators, and other types of applications. While we discuss a mobile device in this document, we also anticipate that this invention could be used on many other devices that use touchscreens, such as laptops, personal computers, embedded computing devices, touch-pads, automobiles with touchscreens, radios with touchscreens, etc.

A user operates the mobile device 101 by holding the device in his hands or placing it on a surface. The user interacts with the mobile device 101 using his fingers to select functionality using the touchscreen 204. By touching the screen, an app may be started or a menu may be displayed so that a second touch of the screen may cause a function on the menu to be executed.

### Hand

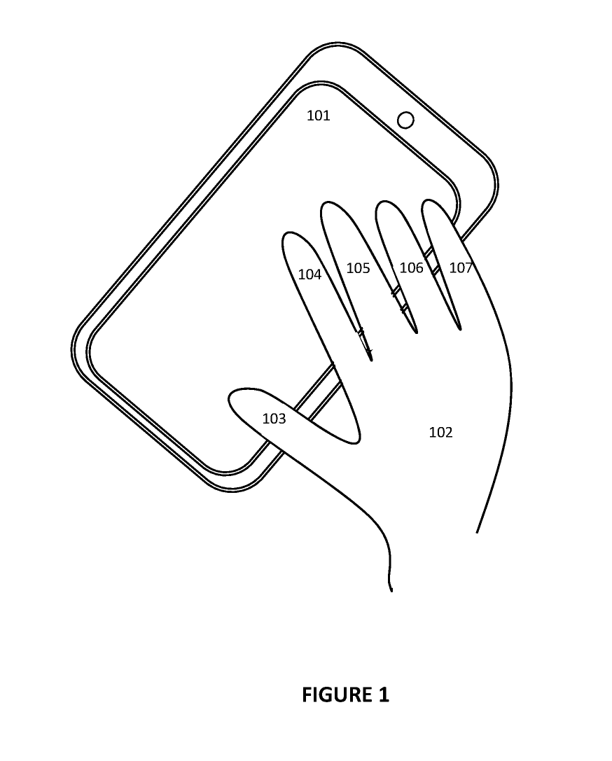

In FIG. 1 we see a hand 102 of the user hovering over the mobile device 101. The hand has five fingers, and for purposes of this application we will refer to them as the thumb 103, the index finger 104, the middle finger 105, the ring finger 106 and the pinky finger 107.

A capacitive touchscreen can “see” the hand hovering above the touchscreen before the finger touches the screen. This allows the touchscreen to see the full hand, and to determine which finger touches the screen by looking at the finger in relation to the rest of the hand. Samsung makes use of hovering with their AirView technology to preview or pop up a window if the finger is hovering above a point on the screen. However, they only look at the closest finger to the screen, and only look up about ¼ inch above the screen.

In one embodiment of the present invention, the touchscreen can see the several of the fingers and can determine which finger is closest to the screen. The software on the device can then assign different functionality based on which finger is touching the screen. This is described in further detail below. Additional functionality can be assigned to hovering fingers in addition to the functionality assigned to fingers actually toughing the screen.

### Touchscreen

FIG. 2 shows a mobile device 101 with a camera 201 mounted at the top of the screen 203. The mobile device 101 has a touchscreen 204 as described in US Patent Publication US2014/0310804A1. The projected capacitive grid structure of the touchscreen 204 can be used to capture enough information to verify which finger that the user is using, even while the user is not consciously engaged in an active verification interface. Realize that a typical touchscreen 204 consists of a grid pattern of wires spaced about 5-7 mm apart.

A finger “image” algorithm provides finger identification from a sparse data set, sufficiently accurate for determining which finger is touching the screen. The projected capacitance touchscreen 204 presents an especially attractive and transparent method to accomplish this active user verification.

More particularly, as a user's finger 103-107 impedes the proximity of an electrode at the intersecting wires of the grid on the touchscreen 204, the mutual capacitance between electrodes is changed. Fingerprint ridges are approximately 0.5 mm wide. As the user's finger slides up, down, and across the touchscreen grid during normal interaction with the smartphone (using application software and other functions), the ridges and valleys of the fingerprint are sensed by the difference in mutual capacitance of a ridge versus a valley in proximity to a grid collection point. This superimposes a one dimensional (1-D) profile in time of the “fingerprint terrain” imposed on the intersecting wires. At any given time, the finger could be traversing several collection points in the grid. Each such collection point adds information to the data set, and the data set grows over time proportional to the amount of touch activity. This can occur continuously, even when the user is not actively or consciously engaged in a process to review the fingerprints.

The data set contains many 1-D “terrain profiles” of the finger in various orientations, collected over time. This sparse data set is then correlated to a previous enrollment of the user's fingers. Data collected by the grid of sensors is compared to a database of previously authorized, enrolled user's fingerprints for each finger.

The process of identifying the finger can proceed in the background, with the processor simply verifying that the same finger is being used. With the low processing overhead of this technology, the smart phone processor can continue to work on other processing. Only when the 1-D terrain profile does not meet the existing finger will the processor look at the profiles of the other 9 fingers to see which one is in use at that moment. For a more detailed description, see US Patent Publication US2014/0310804A1, incorporated here by reference.

### User Interface

With this process, it is possible to identify which finger 103-107 is touching the touchscreen 204, and being used to interact with the smartphone 101. For instance, the features of a mouse could be implemented on a touchscreen using the fingers of one hand and the absolute location of a touchscreen could be mapped to the fingers of the other hand. This would make a touchscreen operate the same as a touch pad, and a touchpad using this technology could operate in relative mode like a touchscreen. By mapping functionality to different fingers, the hover features of the Samsung AirView could be replaced, as could the Apple pressure sensitive screen functionality. For instance, the ring finger could be assigned to the same functionality as Apple assigns to the pressure contact to the screen. The Android press and hold could be assigned to another finger, and the two finger usage on the touchscreen could be assigned to still another finger. The double tap or tap and drag functionality to copy text could be mapped to still another finger, perhaps the right ring finger, for example.

This leads to finer control of the curser and to the selection of point on the screen without having to worry about double clicks and pressure impacts. This may also held relieve carpal tunnel and other finger related injuries from touchscreen use.

There are several methods for determining which finger is used, as described elsewhere in this document: using fingerprints to determine which finger is being used, using the view of the overall hand from the capacitive touchscreen, or using the cell phone (or other devices) camera to look at the hand.

Essentially, the fingers become keyboard (or functionality) shortcuts that can be mapped in any way that the user or programmer see fit. Various functions could be assigned to each finger 103-107. For instance, the following chart could show the functions allocated to each finger:

| FINGER | HAND | ACTION | MODE | FUNCTION |
|---|---|---|---|---|
| Index 104 or | Right | Click | Absolute | Select |
| thumb 103 | | | | |
| | Right | Swipe | Absolute | Move/scroll |
| | Right | Hover | Absolute | Show |
| | | | | links below |
| Middle 105 | Right | Click | Absolute | Pull |
| | | | | down menu |
| Ring 106 | Right | Drag | Absolute | Copy |
| Pinky 107 | Right | Click | Absolute | Paste |
| Index 104 or | Left | Click | Relative | Left |
| Thumb 103 | | | | mouse click |
| | Left | Drag | Relative | Relative |
| | | | | movement |
| | | | | of cursor |
| Middle 105 | Left | Click | Relative | Right |
| | | | | mouse click |
| Ring 106 | Left | Swipe | Relative | Relative scroll |
| | | | | movement |

A user interface in modern computers essentially has two modes, one relative and the other absolute. A touchscreen uses an absolute mode, selecting where the finger strikes the screen. Typically, there is no cursor in absolute mode. The relative mode (similar to a mouse) includes a cursor on the screen, and is similar to the movement of a mouse, where the any swipe movement is relative to the last location of the cursor. In the above example, the left hand uses mouse mode and the right hand uses touchscreen mode, although it is envisioned that users and providers could use other assignments of these and other functions.

Note the difference between a drag and a swipe. A drag starts at a specific location on the screen and ends at another specific location. The functionality involves the material between the start and end locations. A swipe is a relative movement between two locations that have no relevance to the touchdown and lift up locations on the screen.

### Keyboard Mode

When typing on a keyboard on a touchscreen device, frequently the keyboards are small and include a subset of the keys available on a physical keyboard. For instance, there is rarely a shift key, an alt key or a control key. On a physical keyboard, the shift, alt or control keys are simultaneously held with another key to modify the function of the key. On the touchscreen keyboard, it requires three keystrokes to create a capital letter, for instance (shift, the key, and shift back). On a physical keyboard, it requires a dual keystroke (shift and key held simultaneously). In one embodiment of the device described in this document, different fingers could be assign different functions on the touchscreen keyboard. For instance, the index finger 104 could be mapped to lower case letters, the middle finger 105 could be mapped to capital letters, the ring finger 106 could be the control functions, and the pinky finger 107 could be mapped to the alt functions.

The thumb 103 could be mapped to punctuation, so if the user wanted to type We'd, a thumb 103 tap on the “d” would product 'd. In another embodiment, one finger could be assigned to create a new paragraph.

### Absolute Mode

In the above chart, when the thumb 103 or index finger 104 of the right hand taps or clicks on the screen, the item on the screen at the location is selected. If the item is double clicked, then any item at the location is opened. This is in absolute mode.

If the thumb 103 of index ringer 104 of the right hand swipes the screen, then the screen is scrolled or a selected item is moved to a position under the finger. This is in absolute mode.

If the thumb 103 or index finger 104 of the right hand hovers above, but does not touch the screen (capacitive touchscreens have the ability to “see” a finger above the screen), then show the links below the finger. Again, this is in absolute mode.

When the middle finger 105 of the right hand touches the screen at a pull down menu, the menu is opened. This is in absolute mode.

When the ring finger 106 of the right hand is dragged across an area of the screen, the area between the point where the finger first hits the screen and when it is lifted is selected and copied into the paste buffer. This is in absolute mode.

Then the pinky finger 107 of the right hand is tapped on the screen, then the paste buffer is pasted in at that absolute location on the screen.

### Relative Mode

If the index finger 104 or thumb 103 of the left hand touch (or tap or click) on the screen, this is a left mouse click in relative mode. The location where the cursor is located is then selected.

When the index finger 104 or thumb 103 of the left hand is swiped or dragged across the screen, the cursor is moved relative to its current location.

If the middle finger 105 of the left hand taps the screen, this is the functionality of the right mouse click, and performs that function at the location of the cursor. This is in relative mode.

The swiping or dragging of the ring 106 finger of the left hand performs a scroll function similar to the wheel on a mouse, relative to the location of the cursor.

Naturally, one of skill in the art could provide different mappings of functions to touchscreen inputs without deviating from the present inventions.

### Basic Mode

In order to make sure that the mobile device is always operational, certain functions could be fixed so that they are always operational. For instance, the emergency dialer functionality could always work with any finger. And if the functionality may also be set into basic mode if the phone determines that the driver is driving (by monitoring the speed from the accelerometer). In some embodiments, the functionality could be different when the device is flat on a surface as opposed to being held by the user.

### Guest Mode

With the ability to distinguish fingerprints, the touchscreen could be configured to operate in a different mode when foreign fingerprints are seen. For instance, only the phone could be enabled if unrecognized fingerprints are seen. In another embodiment, the touchscreen could be configured to recognize other family members, one's children, for example, but would provide limited functionality when the child is using the device. For instance, access to mobile banking, device settings, Play Store, and Voice Mail could be denied access and the child could only use the phone and a web browser.

### Rolled Finger

In another embodiment, the finger could be registered over the sides and the pad of the finger, and the touchscreen could detect the position of the finger on the screen. If the user is using the side of the finger, the inputs could be interpreted in relative (mouse) mode. If the user hits the screen using the pad or tip of the finger, then the inputs are interpreted as absolute (touchscreen mode).

In another embodiment, the finger could be rolled on the touchscreen to indicate that the user would like to peak into or open a link on the screen.

### Camera Embodiment

In another embodiment, which finger is touching the screen could be determined by using one or more cameras 201 with wide angle lenses to allow the camera to see all corners of the screen. The camera could see and determine, using image recognition techniques, which finger(s) were touching the screen, and perform the above functions based on the fingers that the camera sees.

The foregoing devices and operations, including their implementation, will be familiar to, and understood by, those having ordinary skill in the art.

The above description of the embodiments, alternative embodiments, and specific examples, are given by way of illustration and should not be viewed as limiting. Further, many changes and modifications within the scope of the present embodiments may be made without departing from the spirit thereof, and the present invention includes such changes and modifications.

1. A device with enhanced touchscreen functionality comprising:
a touchscreen;
a processor electronically coupled to the touchscreen;
a memory coupled to the processor;
the touchscreen having a projective capacitive grid structure;
the projective capacitive grid structure used to record a fingerprint input for each finger of a user;
the processor specifically programmed with a finger image algorithm to determine a finger profile of a user based on the fingerprint input;
the finger profile stored in the memory; and
the processor assigning one or more functions to the finger profile.

2. The device of claim 1, wherein the one or more functions include keyboard shortcuts.

3. The device of claim 1, wherein the processor implements a different device mode if the finger profile is not recognized in the memory.

4. The device of claim 1, wherein the one or more functions include a click, drag, or swipe.

5. The device of claim 1, wherein the device is a smartphone.

6. The device of claim 1, wherein the device is a tablet.

7. The device of claim 1, wherein the device is a laptop.

8. The device of claim 1, wherein the one or more functions include gestures.

9. The device of claim 1, wherein the one or more functions include a double tap.

10. The device of claim 1, wherein the one or more functions includes a pressure sensitive function.

11. The device of claim 1, wherein the one or more functions includes a tap and drag function.

12. A method for enhancing functionality of a touchscreen on a device comprising:
receiving a fingerprint input from a projective capacitive grid structure on the touchscreen;
executing a finger image algorithm on a processor to determine a finger profile of a user based on the fingerprint input;
storing the finger profile in a digital memory; and
assigning one or more functions to control the device to the finger profile.

13. The method of claim 12, wherein the one or more functions include keyboard shortcuts.

14. The method of claim 12, wherein the processor implements a different device mode if the finger profile is not recognized in the digital memory.

15. The method of claim 12, wherein the one or more functions include a click, drag, or swipe.

16. The method of claim 12, wherein the device is a smartphone.

17. The method of claim 12, wherein the device is a tablet.

18. The method of claim 12, wherein the device is a laptop.

19. The method of claim 12, wherein the one or more functions include gestures.

20. The method of claim 12, wherein the one or more functions include a double tap.

21. The method of claim 12, wherein the one or more functions includes a pressure sensitive function.

22. The method of claim 12, wherein the one or more functions includes a tap and drag function.
